(19) United States
(12) Patent Application Publication
(10) Pub. No.: US 2012/0168455 A1
(43) Pub. Date: Jul. 5, 2012

(54) Detactable Handle For Cookware

(76) Inventor: Michael Doyle, Falmouth, ME (US)

(21) Appl. No.: 13/339,529

(22) Filed: Dec. 29, 2011

Related U.S. Application Data
(60) Provisional application No. 61/428,354, filed on Dec. 30, 2010.

(51) Int. Cl. A47J 45/07; A47J 45/10

(52) U.S. Cl. 220/759

(57) ABSTRACT

The invention is a handle that is detachable from cookware, to allow cookware to be stored more efficiently. The handle includes a handle receiver that is affixed to cookware and a handle with a coupling end that is insertable into the handle receiver. A locking mechanism automatically locks the handle into the handle receiver. The handle is detachable from the handle receiver by pushing on a release mechanism, which then allows the handle to be pulled away from the handle receiver.

### BACKGROUND INFORMATION

1. Field of the Invention

The invention relates to cookware. More particularly, the invention relates to a detachable handle for cookware.

2. Discussion of Prior Art

Handles on cookware, such as pots, pans, skillets, etc., make it difficult to place the cookware in a dishwasher and generally take up space when storing them. The handles are conventionally permanently affixed to the cookware.

Some camping sets of cookware have a skillet or pots with a detachable or a hinged handle that folds over the cookware for compact storage. Typically, camping cookware is designed to be lightweight and compact, is generally small, and is not constructed as rugged long-lasting cookware for conventional household use. The concept of the hinged or detachable handles, as used in camping gear, is not suited for conventional household use, because it does not meet general standards for safety, reliability, and durability.

Quick-release ball locks are known in the tool industry, such locks being commonly used on socket wrenches and other tools, for locking a socket or tool bit onto the tool. Various configurations and embodiments of the ball lock are known. Early versions of the ball lock are disclosed in U.S. Pat. No. 2,987,334 (Wendling; 1961) and U.S. Pat. No. 3,172,675 (Gonzalez; 1965). US Design Patent D 597,388 S (Davidson; 2009) discloses a socket wrench which has such a ball lock for securing a variety of sockets to the handle. The socket wrench disclosed in that patent is commercially available as the Craftsman® brand inch and metric universal socket wrench set 24963. These patents are incorporated herein in their entirety and are relied upon to disclose structural details of the quick-release ball lock used according to the invention in conjunction with cookware. Particular reference is made to FIGS. 1-4 of Wendling for the structural details of the conventional ball lock mechanism.

What is needed is a handle for heavy-duty rugged cookware that is readily attachable to and detachable from cookware. What is further needed is such a handle that is attachable and detachable with the use of one hand only. What is yet further needed is a coupling mechanism that will provide a secure coupling of such a handle with cookware.

### BRIEF SUMMARY OF THE INVENTION

The invention is a handle that is easily and quickly attachable to and removable from cookware, such as a skillet or saucepan. The handle has a quick-release mechanism and a coupling element that couples with a receiver on the cookware. The handle is sturdy and provides a secure means for lifting and maneuvering cookware. Pots and pans are easier to load into a dishwasher and take up less space when the handles are removed. Storing cookware in a cupboard is also easier and also allows better use of space, if the handles are removed. The detachable handle according to the invention allows the handle to be removed from the pot or pan for storage and cleaning purposes, yet couples securely with the cookware when attached.

The removable handle with the quick-release coupler is rugged and capable of withstanding high compression, tension, and torque loads, which makes it safe and reliable for use in supporting cookware that may be heavy and very hot.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 is a perspective view of a first embodiment of a detachable handle according to the invention.

FIG. 2 is a bottom plan view of the handle.

FIG. 3. is a side elevation view of the handle.

FIG. 4 is a top plan view of the handle.

FIG. 5 is a rear plane view of the handle.

FIG. 6 is front plan view of the handle.

FIG. 7 illustrates the cookware connector.

FIG. 8 illustrates the cookware coupler.

FIG. 9 illustrates the locking mechanism with pivot means.

FIG. 10 illustrates the upper handle body.

FIG. 11 illustrates the lower handle body with handle coupler.

FIG. 12 illustrates the release mechanism.

FIG. 13 is a perspective view of the handle of FIG. 1 attached to the cookware.

FIG. 14 is a side plan view of a second embodiment of a detachable handle according to the invention, showing the handle detached from the cookware.

FIG. 15 is front plan view of the handle receiver on the cookware.

FIG. 16 is a top plan view of the handle receiver.

FIG. 17 is a side plan view of a second embodiment of the receiver component according to the invention, showing the receiver body in cross-section

FIG. 18 is a top plan view of the second embodiment of the detachable handle, showing the male coupling shaft and the actuating button.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

The term “cookware” as used herein shall encompass food preparation receptacles, such as, but not limited to, skillets, pots, and pans.

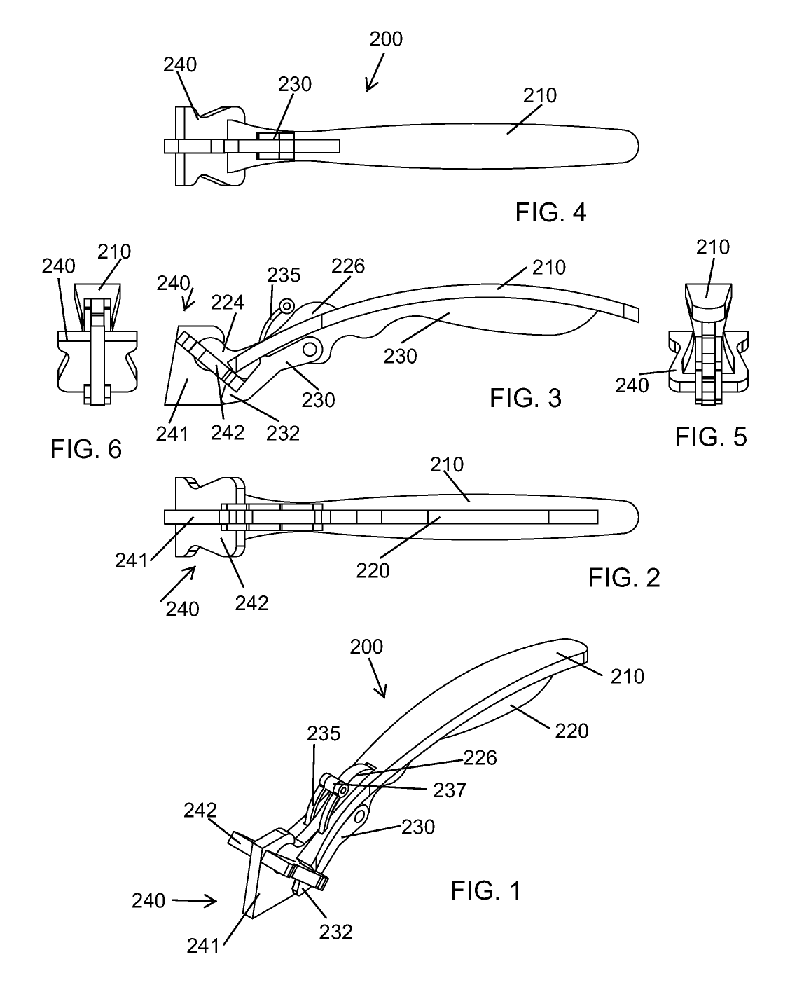

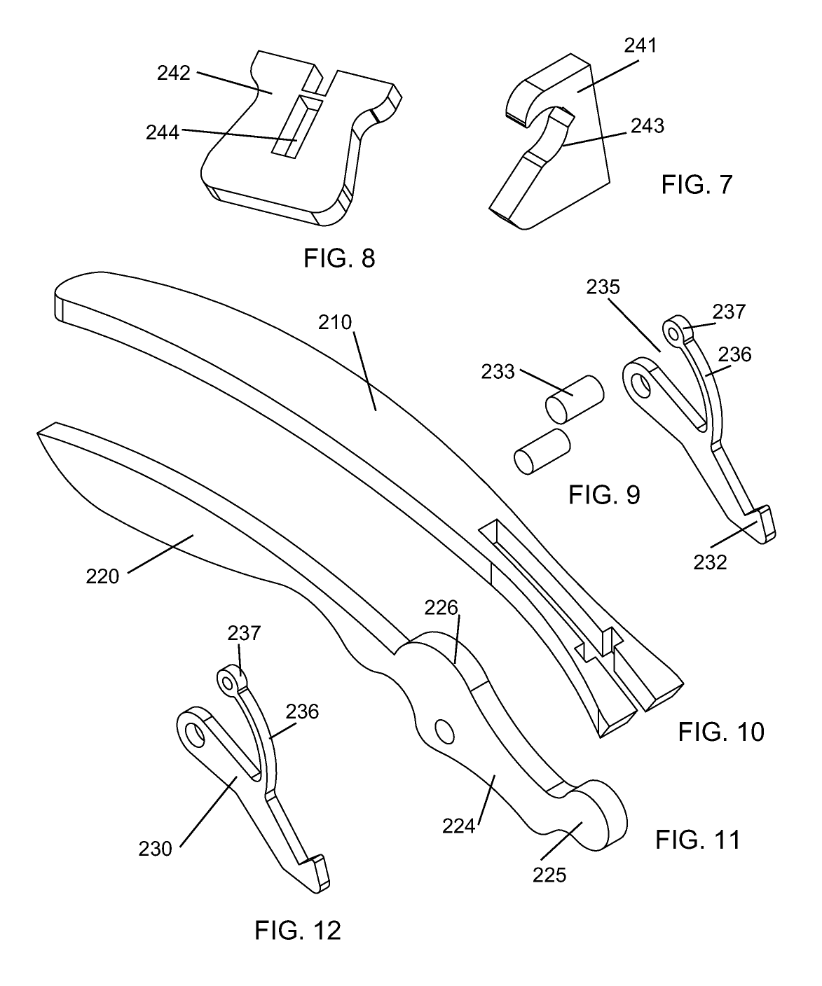

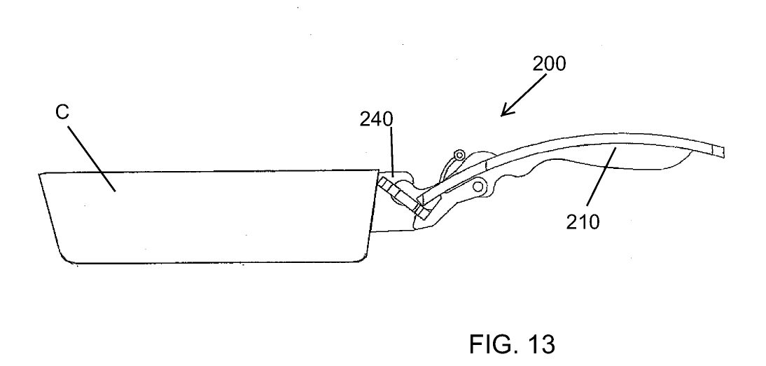

FIGS. 1-13 illustrate a first and preferred embodiment of a detachable handle 200 according to the invention. The detachable handle comprises a handle 210 that is couplable with a handle receiver 240 that is attached to cookware. FIGS. 1-6 show the handle 210 coupled to the handle receiver 240, without the cookware; FIGS. 7-12 illustrates the various components of the detachable handle 200; FIG. 13 illustrates the handle 200 attached to cookware C.

The handle 210 has an upper handle body 212 and a lower handle body 220. The lower handle body 220 includes a grip 222 and a coupling end 224 that couples with the handle receiver 240. The handle 210 is shown as having separate components 212 and 220, but it is understood, that the handle may be constructed as a single-component piece. The coupling end 224 has a projecting portion 225 for inserting into the handle receiver 240. A locking mechanism 230 with a catch 232 and a release mechanism 235 is pivotably affixed to the coupling end 224 by means of pivot pin 233. The catch 232 is spring-biased to an upward position, which, then the handle 210 is coupled with the handle receiver 240, locks the projecting portion 225 into the handle receiver 240. The release mechanism 235 is constructed as an arm 236 that is a rigid portion of the body of the locking mechanism 230 with a push body 237 on the end of the arm. Force exerted on the push body 237 in the direction of the handle receiver 240 rotates the catch end of the locking mechanism 230 downward about the pivot pin 233, thereby moving the catch 232 away from the handle receiver 240 and allowing the coupling end 224 to be removed from the handle receiver. The locking mechanism 230 is shown here constructed as separate left and right side components, but it is understood that the mechanism may be constructed as a single bifurcated component, with the solid push body linking the left and right sides of the mechanism.

The handle receiver 240 as shown in this embodiment comprises a locking flange 242 that is fixedly attached to or integrated into the construction a fixed coupler body 241. The fixed coupler body 241 is affixed to the piece of cookware by some suitable means, preferably permanently. For example, the fixed coupler body 241 in the embodiment shown is intended to be welded to the cookware, but it is also possible to provide flanges on the body 241 for riveting the body to the cookware. The locking flange 242 is welded or integrally formed with the fixed coupler body 241. A through-slot 244 is provided in the locking flange 242 for receiving the projecting portion 225 of the lower handle body 220. The fixed coupler body 241 has a contour 243 that is shaped to receive the projecting portion 225. The projecting portion 225 has a contour that allows it to be inserted into the handle receiver by tilting the far end of the handle 210 upward and inserting the projecting portion 225 into the through-slot 244 and the fixed coupler body 241. The far end of the handle 210 is then rotated downward until the catch 232 on the locking mechanism 230 snaps into place on the lower side of the locking flange 242. The fixed coupler body 241, the locking flange 242 and the catch 232 together provide a secure hold for the handle 210 in the handle receiver 240. If no force is exerted on the push body 237 in the direction of the handle receiver 240, the insertion end 225 of the handle 210 remains locked into the handle receiver 240.

A rounded portion 226 of the lower handle 220 extends upward from the upper handle 212 just rearward of the push body 237. The purpose of this protrusion is to prevent a user from inadvertently pushing on the push body 237 and releasing the handle 210 from the handle receiver 240. When the handle

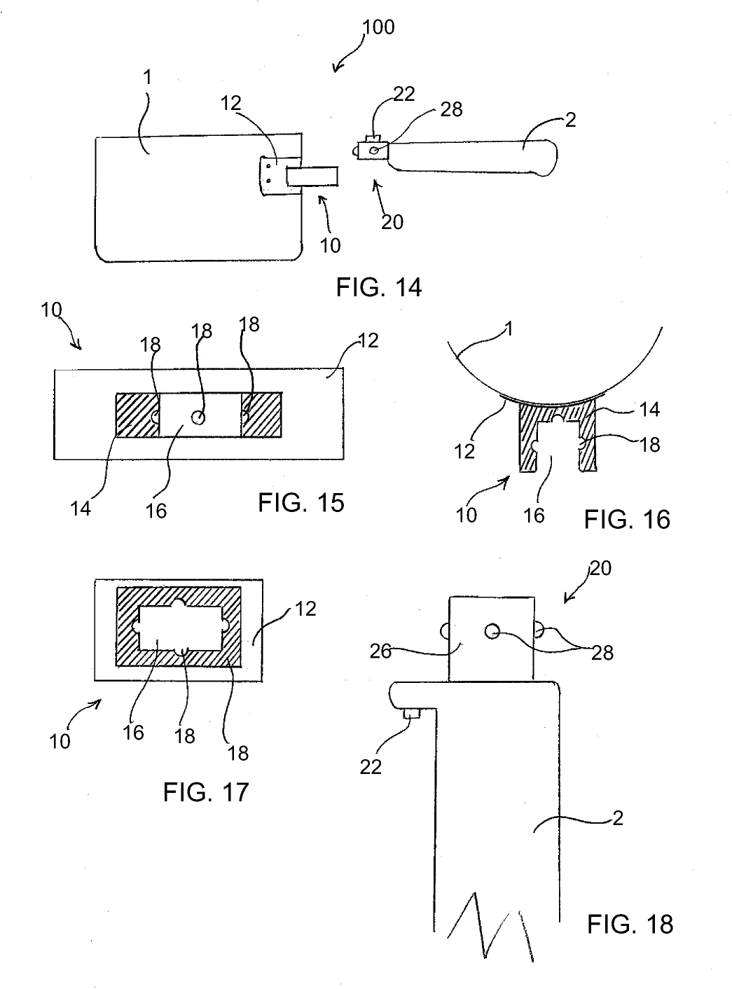

FIG. 14 is a schematic illustration of a second embodiment of a detachable handle assembly 100 comprising a receiver component 10 and a handle 2 that has a detachable coupler 20 into which is incorporated a quick-release ball lock mechanism for coupling the handle 2 with the receiver component 10. The receiver component 10 is permanently and securely affixed to an article of cookware 1.

FIG. 15 illustrates details of a first embodiment of the receiver component 10, which includes a mounting flange 12 and a receiver body 14. The receiver body 14 has an opening 16 that is contoured and sized to receive the detachable coupler 20. A groove or detent 18 for receiving a portion of the lock ball 28 is provided on at least one surface of the opening 16. In the embodiment shown in FIGS. 16 and 17, the groove 18 is shown on three side walls of the opening 16, but it is understood, that the groove 18 may be provided on just one surface or on two opposing surfaces. In the embodiment illustrated in FIG. 15, the coupler 20 is lowered into the receiver body 14 from above. This is a design choice. The handle may just as well be constructed such, that the coupler 20 is inserted into the receiver body 14 from below.

A brief description of the mechanism is provided here, with reference to the Wendling reference cited above, to provide an enabling disclosure of a suitable ball lock. The conventional ball lock comprises a receiver body that has recess or grooves for receiving a ball and a handle or holder with a coupler, into which is incorporated a spring-biased plunger or movable rod that carries a ball that is movable on the plunger between a lock position and a release position. Typically, the plunger has a deep groove or recess in it to allow the ball to drop down into it, to a non-locking or release position, and a flange, a shallow recess, or some other increased dimension relative to deep groove, which forces the ball radially outward from the plunger. When the coupler is inserted into the receiver body, the ball is engaged in a recess in the receiver body and the spring-biased plunger prevents the ball from retracting from the recess. The receiver body and coupler have mating contours in a shape that prevents the coupler from rotating in the receiver body, such as rectangular or triangular shapes. FIGS. 1-4 in Wendling, for example, disclose the structural details of the lock-ball mechanism used on a tool holder (10), for detachably coupling a socket (11) to the tool holder. The figures illustrate a spring-biased plunger (33,30) with a deep groove (43) for holding a ball (25) in a release position and a shallow groove (42) for holding the lock ball (25) in the locked position. Wendling FIG. 3 illustrates a number of grooves (44) on the various surfaces of a dimensioned opening, for receiving a corresponding number of the lock ball (25).

FIG. 17 illustrates details of the detachable handle 2. The detachable coupler 20 is a shaft or bar that extends from the handle 2. An actuating button 22 is provided on a readily accessible area of the handle 2. Incorporated into the coupler 20 is a plunger for moving a lock ball 28 between a lock position and a release position, similar to the mechanism described above with reference to Wendling. The plunger is spring-biased to the lock position, in which a portion of the lock ball 28 extends beyond the surface of the coupler 20. Depressing the actuating button 22 forces the lock ball 25 to move to the release position, in which no portion of the ball extends beyond the surface of the coupler 20. While the button 22 is depressed, the coupler 20 may be inserted into the receiver body 14. Releasing the actuation button 22 forces the lock ball 28 back into the lock position. The lock ball 28 extends into the recess 18 in the receiver body 14. The geometry of the spring-biased plunger prevents the lock ball 28 from dropping back into the release position.

FIGS. 15 and 16 illustrate a second embodiment of the handle receiver 12 according to the invention. The receiver body 14 in this embodiment is open on a side that is tangential to the curved body of the cookware 1, assuming the cookware is round. The coupler 20 has a coupling shaft 26 that is inserted into the receiver body 14 in a radial direction, relative to the curved wall of the cookware. The actuating button 22 is in a readily accessible area near the coupling shaft 26.

FIG. 17 shows that the mounting flange 12 is riveted to the cookware 1. It is understood, however, that other conventional means may be used to affix the mounting flange 12 to the cookware 1.

It is understood that the embodiments described herein are merely illustrative of the present invention. Variations in the construction of the detachable handle for cookware may be contemplated by one skilled in the art without limiting the intended scope of the invention herein disclosed and as defined by the following claims.

What is claimed is:

1. A detachable handle for cookware comprising:
a handle receiver that is affixed to the cookware;
a handle for releasably coupling with the receiver body;
a coupler extending from an end of a handle; and
a locking and release mechanism rotatably mounted on the handle, the locking and release mechanism including a locking mechanism and a release mechanism;
wherein the locking mechanism is spring-biased to a locking position and wherein the release mechanism is actuatable by a user pushing on the release mechanism.

2. The detachable handle of claim 1, wherein the handle has a coupling end with a projecting portion and the handle receiver includes a coupler body and a locking flange that receive the projecting portion, and wherein the locking mechanism locks onto the locking flange, so as to lock the handle into the handle receiver.

3. The detachable handle of claim 2, wherein the locking flange has a through-slot through which the projection portion is inserted into the fixed coupler body, the through-slot maintaining proper orientation of the handle.

4. The detachable handle of claim 1, wherein the release mechanism is fixed relative the locking mechanism, the release mechanism having a push body, which, when pushed, rotates the locking mechanism on the locking and release mechanism away from the locking flange.
